(19) United States
(12) Patent Application Publication
(10) Pub. No.: US 2020/0320497 A1
(43) Pub. Date: Oct. 8, 2020

(54) MESSAGING TRANSACTION APPLICATION

(71) Applicant: eBay Inc., San Jose, CA (US)

(72) Inventors: Pablo Flores, San Jose, CA (US); Barney Mok, San Jose, CA (US); Kevin Guo, San Jose, CA (US); Carlos Lopez, San Jose, CA (US); Jayanth Vasudevan, San Jose, CA (US)

(21) Appl. No.: 16/908,479

(22) Filed: Jun. 22, 2020

Related U.S. Application Data
(63) Continuation of application No. 15/653,271, filed on Jul. 18, 2017.
(60) Provisional application No. 62/363,747, filed on Jul. 18, 2016.

(51) Int. Cl. G06Q 20/20; G06Q 30/06; H04L 12/58; G06Q 30/02; G06Q 30/00; G06Q 50/00; G06Q 10/10; G06Q 20/12

(52) U.S. Cl. CPC G06Q 20/20; G06Q 30/0631; H04L 51/046; H04L 51/04; G06Q 30/02; H04L 51/32; G06Q 50/01; G06Q 30/0641; G06Q 10/107; G06Q 20/12; G06Q 30/00

(57) ABSTRACT

Embodiments of the present disclosure are related to electronic commerce within instant messaging. A system may include a commerce server and an instant messaging server. The instant messaging server is configured to support an instant messaging service with an instant messaging client. The instant messaging server may include an application for supporting further communication in the instant messaging service between the instant messaging client and the commerce server. The method includes first instant messaging a query to an instant messaging client and receiving a response to the query at an application at an instant messaging server. The method further includes second instant messaging query results to the instant messaging client with the query results determined at a commerce server and based on the response.

### CROSS REFERENCES

This application is a continuation of U.S. patent application Ser. No. 15/653,271 by Flores et al., entitled “Messaging Transaction Application,” and filed on Jul. 18, 2017; which claims the benefit of and priority to U.S. Provisional Application No. 62/363,747 by Flores et al., entitled “Messaging Transaction Application,” and filed on Jul. 18, 2016; each of which is incorporated herein by reference in its entirety.

### FIELD

The present application relates generally to the technical field of network-based commerce and, in one specific example, to purchasing using instant messaging clients.

### BACKGROUND

In typical networked-based commerce systems, a buyer can enter a commerce system's web-site and from the listings published in the web-site, select a desired listing and participate in a selection and purchasing process. If a user is engaged in social media or in an instant messaging application, such a commerce interaction requires the user to first exit or navigate away from the social media program and secondly enter the commerce web-site. Such a process may be disruptive or discourage a user from engaging in a commerce transaction.

The subject matter claimed herein is not limited to embodiments that solve any disadvantages or that operate only in environments such as those described above. Rather, this background is only provided to illustrate one example technology area where some embodiments described herein may be practiced.

### BRIEF DESCRIPTION OF THE DRAWINGS

Example embodiments will be described and explained with additional specificity and detail through the use of the accompanying drawings in which:

FIG. 1 illustrates a block diagram of an instant messaging system with in-message access to a commerce server, in accordance with an embodiment of the present disclosure;

FIG. 2 is a flowchart depicting a method, in accordance with an embodiment of the present disclosure; and

FIGS. 3A-3G illustrate exemplary user interface queries, responses and results to responses, in accordance with embodiments of the present disclosure.

### DETAILED DESCRIPTION

Example methods and systems to provide access to a commerce service using instant messaging clients are described. For purposes of explanation, numerous specific details are set forth in order to provide a thorough understanding of example embodiments. It will be evident, however, to one of ordinary skill in the art that the present invention may be practiced without these specific details.

Currently, real-time messaging has gained significant support from several service providers and has become a very popular method of communication. Real-time messaging, also known as instant messaging (IM), uses a client program to connect to an instant messaging service to provide the client with instant messaging capability. Most services present features, such as presence information, indicating whether anyone on the contact list of a user is currently online and available for chat.

Presently, several instant messaging services are available on the public internet. The list of most popular ones include, Skype, Qnext, Windows Live Messenger, AOL Instant Messenger, Yahoo! Messenger, Google Talk, .NET Messenger Service, Jabber, and ICQ. Instant messaging increases communication and provides for easier collaboration. On most systems, the user can set an online status or away message to let peers know whether the user is available, busy, or not present at the computer.

Standard instant messaging typically may involve an IM server and Peer-to-Peer (or P2P) instant messaging may rely primarily on the participating users' hardware capability and bandwidth available on the network. The P2P network systems, having a distributed nature, increase the robustness of the network by replacing centralized servers with a cluster of network nodes (computers). The connections between nodes in a P2P network are typically ad hoc connections.

Many P2P networks using overlay protocol are examples of overlay networks. Overlay networks are computer networks built on the top of the internet; the construction of which allow routing of messages to the destinations not specified by IP addresses. Based on how the nodes in an overlay network are linked to each other, one can classify the P2P networks as unstructured or structured. If the overlay links are arbitrarily established, then the network is unstructured. Most popular P2P networks such as Skype, Napster, Gnutella, and KaZaA are unstructured.

Structured P2P networks on the other hand maintain a Distributed Hash Table (DHT) and allow for each peer to be responsible for a specific part of the content on the network. Some well known structured P2P networks are: Chord, Pastry, Tapestry, CAN, and Tulip.

Real time communication cooperative with a network-based commerce system and its clients is a challenge in existing systems. For example, if a user is engaged in social media or in an instant messaging application, such a commerce interaction requires the user to first exit or navigate away from the social media program and secondly enter the commerce web-site. As stated, such a process may be disruptive or discourage a user from engaging in a commerce transaction.

A system and method are described herein. The system includes a commerce server and an instant messaging server. The instant messaging server is configured to support an instant messaging service with an instant messaging client. The instant messaging server may include an application for supporting further communication in the instant messaging service between the instant messaging client and the commerce server.

The communication in the system may include a query to the commerce server and query results from the commerce server. The query may be for requesting tickets to live events. The instant messaging server may further include a cache operatively coupled to the application for locally providing the query results as previously received from the commerce server in a previous query.

The commerce server may further include a trending events engine configured to provide the query results based on measureable data relating to the query to the commerce server. The trending events engine may select search results bases on the measurable data as trending on social media. Alternatively or in addition to, the measureable data may include inquires at the commerce server. Also alternatively or in addition to, the measureable data may include completed transactions at the commerce server.

Upon selection of a request to find tickets to an event, the messaging server opens a connection between the messaging client and the commerce server when a purchase request is selected at the messaging client.

The method includes first instant messaging a query to an instant messaging client and receiving a response to the query at an application at an instant messaging server. The method further includes second instant messaging query results to the instant messaging client with the query results determined at a commerce server and based on the response. The query results may include results for tickets to live events.

The method may further include caching the query results at the instant messaging server to allow the application to locally provide the query results as previously received from the commerce server in a previous query. Further, the method may include determining at the commerce server the query results based on measureable data relating to the query to the commerce server. The measureable data may include data trending on social media. The measurable data may, alternatively or in addition to, include inquires at the commerce server. Further, the measurable data may, alternatively or in addition to, include completed transactions at the commerce server.

Upon selection of a request to find tickets to an event, the method may include requesting a purchase based on the query results and opening a connection initiated by the messaging server between the messaging client and the commerce server to facilitate the purchase.

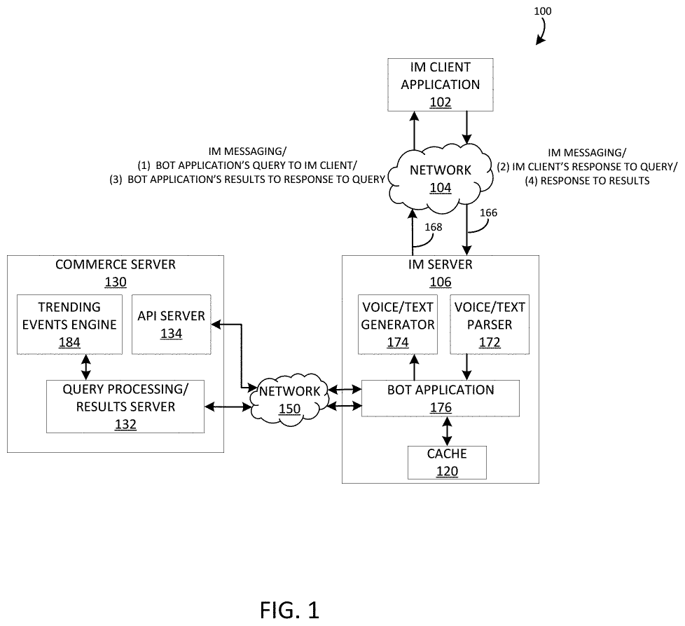

FIG. 1 is a diagram showing an architecture of an example instant messaging (IM) system 100, according to an example embodiment. The instant messaging system 100 supports, for example, peer-to-peer (P2P) instant messaging between an IM client 102 and an IM server 106. In the various exemplary embodiments, the IM server 106 further engages in communication with a commerce server 130. The IM system 100, as an example embodiment, includes one or more clients 102, a network 104, one or more instant messaging servers (e.g., P2P gateway) 106, and one or more commerce servers 130.

The IM client 102 engages in instant messaging with the IM server 106. During conventional instant messaging, the IM client 102 may generate a message 166 that is sent via the network 104 to the IM server 106. The IM server 106 receives the message 166 at a voice/text parser 172. Subsequently, the IM server 106 relays the message to a second IM client (not shown). Similarly, the IM server 106 receives an instant message response from the second IM client and relays the message response 168 to the IM client 102.

As an alternative to instant messaging another IM client, the IM client 102 may initiate an IM session with a bot application 176. The bot application 176 may be one that was selected through an application or bot marketplace not further discussed herein. When instant messaging with the bot application 176, the IM client 102 may initiate a query 166 relating to the capabilities of the specific application bot. Examples of application bots may include commerce bots, such as shopping including a ticket servicing bot application capable of, among other things, searching and recommending events and facilitating the purchase of tickets for such event. The events may include live events such as concerts and sporting events. To initiate such an interaction with the bot application 176, the IM client 102 sends the query 166 through the IM service to the IM server 106.

At the IM server 106, the query 166 is processed by the voice/text parser 172. Because instant messages communicated from the IM client 102 to IM server 106 may comprise text messages, a text parser module 172 may be provided by IM server 106 to parse the text messages received from IM client 102 into their components and convert the components to a data format readable by the bot application 176.

The bot application 176 begins processing the processed query to determine if the processed query may be serviced locally through a bot cache 120 or if the processed query needs to be further processed by the commerce server 130. The bot cache 120 may include data previously populated from previously received response results from previous queries that are trending or may be prepopulated by trending data. Population of the bot cache 120 may expedite future processing of queries by locally servicing queries and locally generating the query results.

The bot application 176 may forward queries over a network 150 to the commerce server for processing. The commerce server 130 may be a server for providing many different types of commerce services, including event ticket sales services such as live events, including sporting events, theatrical performances, concerts, and conferences. Other commerce services may include travel, accommodations, dining, and transit.

According to an example embodiment, the commerce server 130 may include one or more query processing and results generating servers 132, one or more API server(s) 134, and a trending events engine 184. The trending events engine 184 generates query results based on measurable data. For example, the trending events engine 184 may include current commerce transactions such as rates of recent sales for specific events, trending topics on social or conventional media that relate to types or locations of events or performers. The trending events engine 184 may also utilize historical data for a user, through means such as Artificial Intelligence (AI), for generating an evolving profile of specific IM users. The trending events engine 184 may then be tailored for a specific user rather than based on public behaviors.

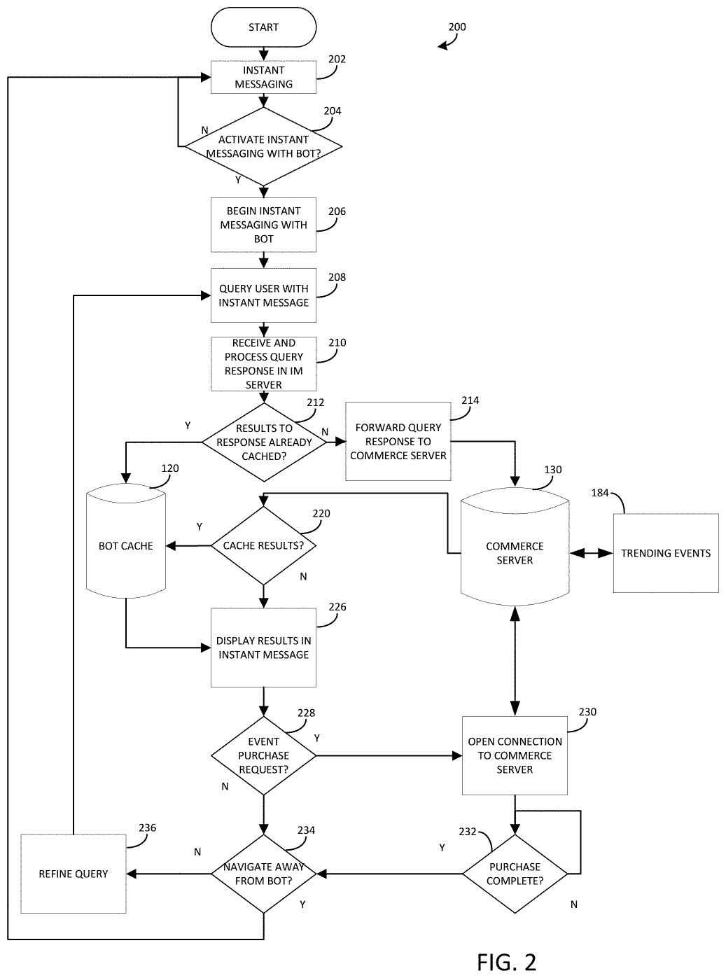

FIG. 2 illustrates a flowchart of communication with a commerce server through an instant messaging service, in accordance with embodiments of the present disclosure. A process 200 illustrates a method for communicating with a commerce server through an instant messaging service. A block 202 depicts an active instant messaging service facilitating instant messaging between a first user of an instant messaging client and a second different member (not shown) of the instant messaging service.

A query 204 determines if the user has selected to message with a bot application. If the instant messaging service determines that instant messaging with a bot application has not been selected, then the user of the IM client 102 continues to engage in an IM session with another IM service user. When the query 204 determines that the user has selected to message with a bot application, then at a block 206, the user of the IM client 102 engages in an IM session with the bot application 176.

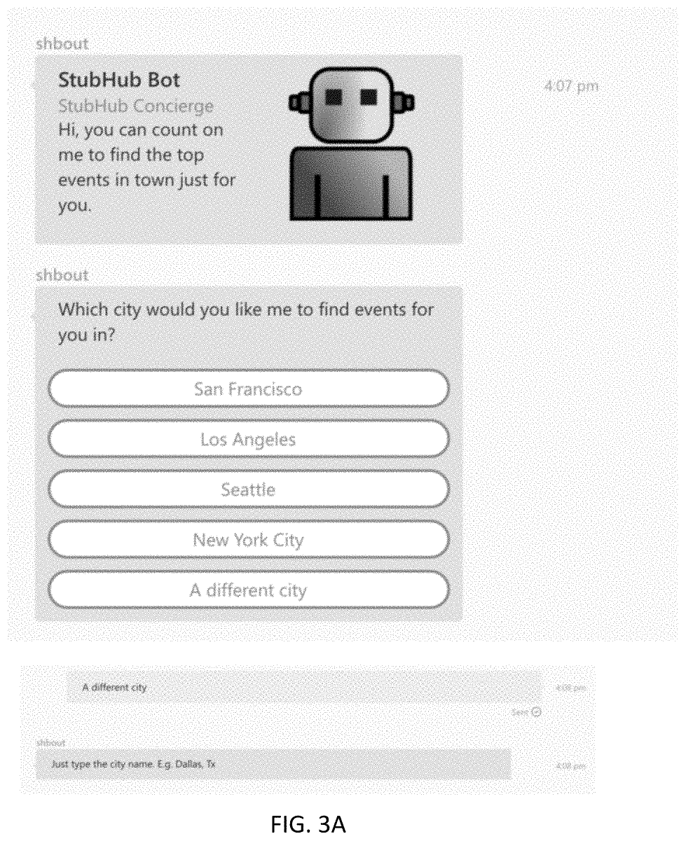

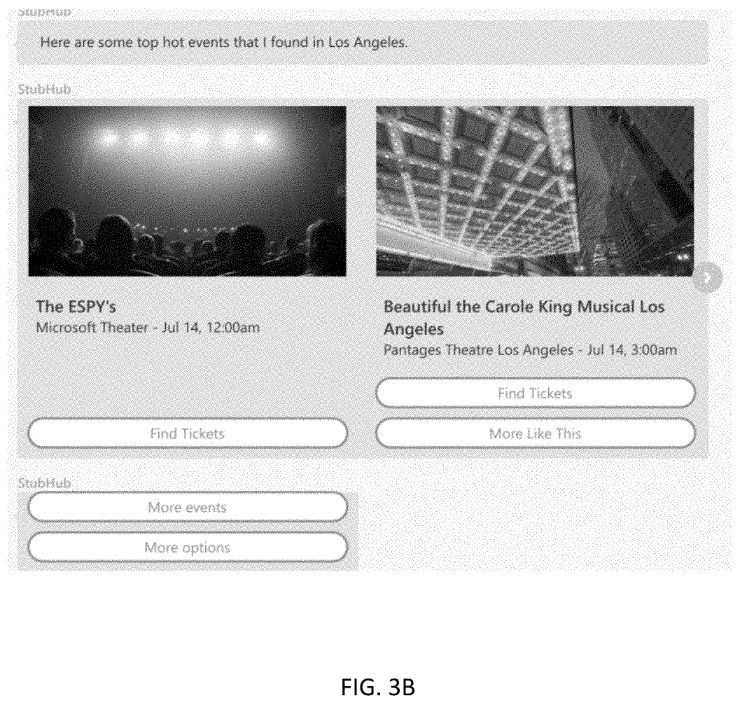

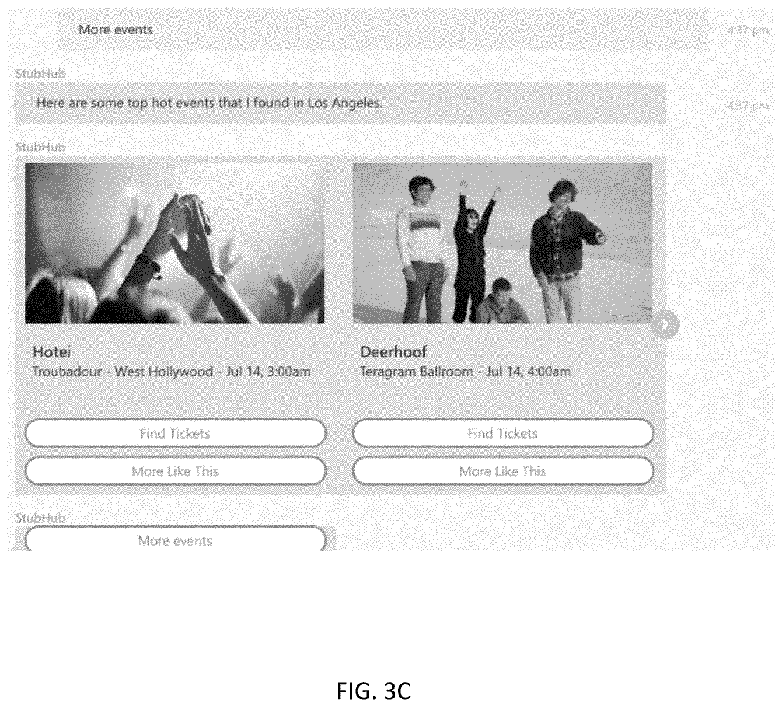

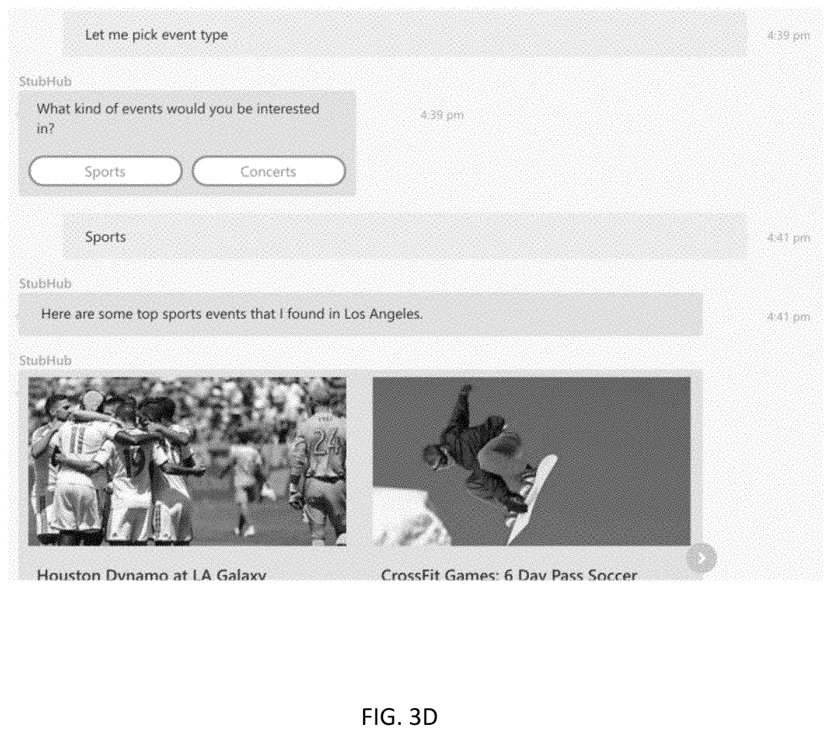

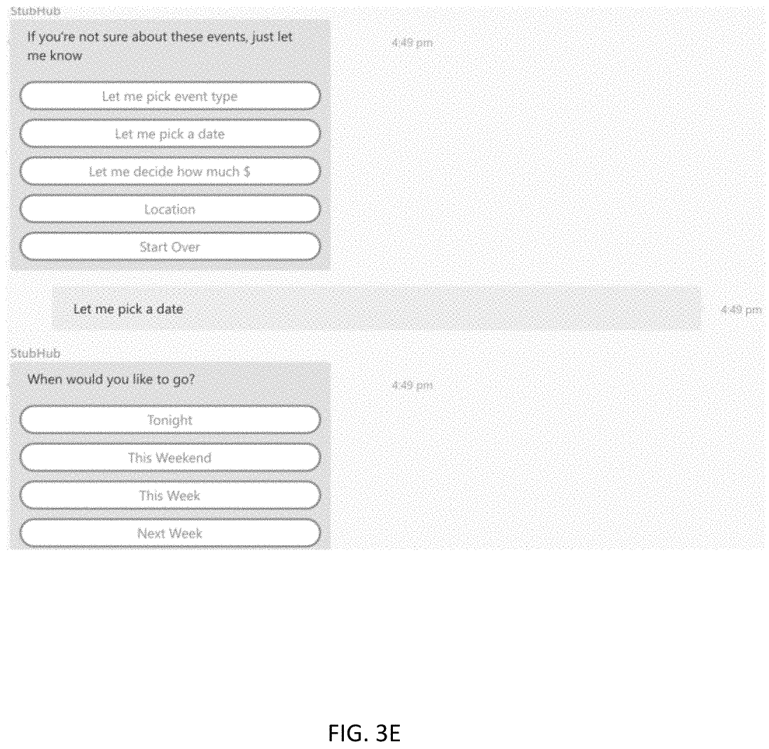

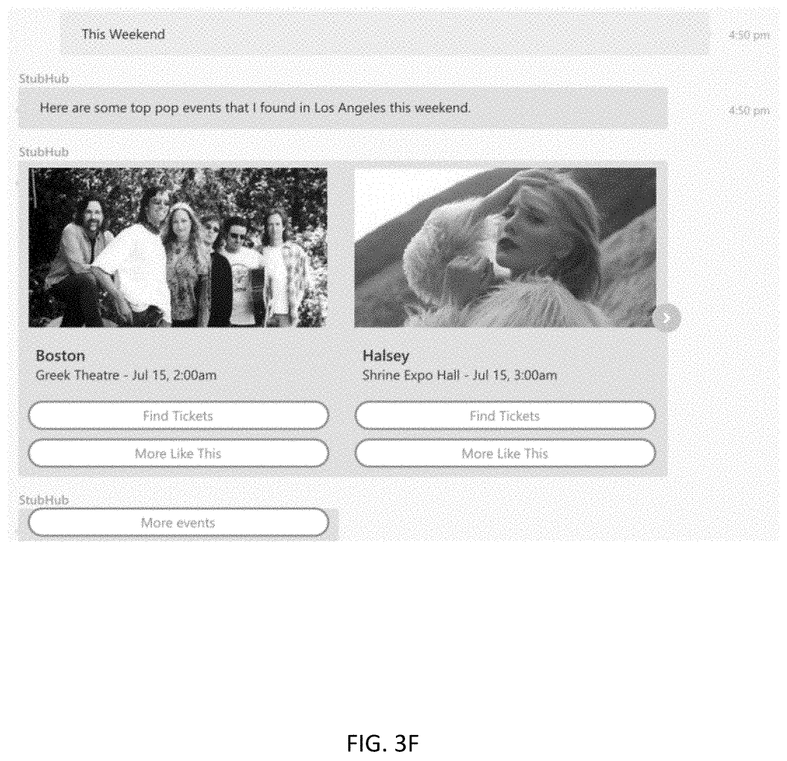

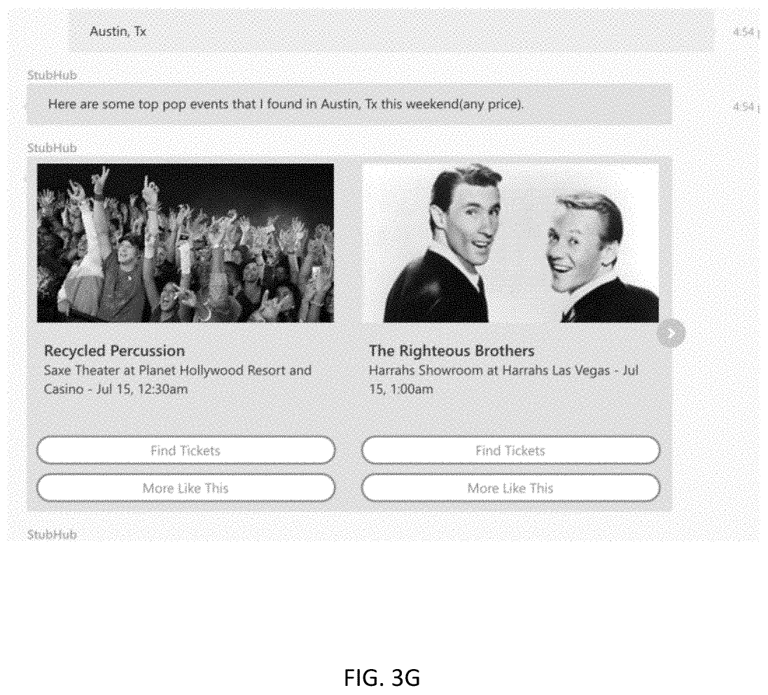

The user of the instant messaging service interacts with the bot application 176 through the IM client 102. At block 208, the bot application 176 issues a query to a user of the IM client 102. An example of the query is illustrated with reference to FIG. 3A. The query from the bot application may include graphical button selection options or may simply pose a question to be answered by an alphanumeric response.

While FIG. 3A illustrates a query that is geographic based, the initial query may be based on various other bases including event type (e.g., sport, theater, live concert, lecture, movies, etc.). For illustrative purposes, the query from the bot application is illustrated as being left-justified, while the response by the user at the IM client appears slightly indented.

In block 210 of FIG. 2, the instant messaging service receives a response to the query from the IM client 102 and parses the query response in the voice/text parser 172 of the IM server 106. The parser 172 generates parsed data and presents the parsed data to the bot application 176.

In bot applications that are sufficiently sophisticated, the bot application 176 in a query 212 determines if results to the query response are already available in a bot cache 120 local to the IM server 106. If results to the query response are available in the bot cache 120, then at a block 226, the results are displayed in the IM service.

If the results to the query response are not available in the bot cache 120, then at a block 214, the query response is forwarded to the commerce server 130. The commerce server 130 may generate results based on various factors.

In one exemplary embodiment, the results may be generated by or in cooperation with a trending events engine 184. The trending events engine 184 may generate query results based on measurable data. For example, the trending events engine 184 may include current commerce transactions such as rates of recent sales for specific events, trending topics on social or conventional media that relate to types or locations of events or performers. The trending events engine 184 may also utilize historical data for a user, through means such as Artificial Intelligence (AI), for generating an evolving profile of specific IM users.

The trending events engine 184 may then be tailored for a specific user rather than based on the public behavior. The commerce server 130 may be a server for providing many different types of commerce services, including event ticket sales services such as live events, including sporting events, theatrical performances, concerts, and conferences. Other commerce services may include travel, accommodations, dining, and transit.

If a query 220 determines if the query response results should be cached at bot cache 120, then the results are stored. A block 226, the results are displayed in the IM service. An example of the display of the results for the query response are illustrated with reference to FIG. 3B.

An example of the display of the results for the query response are illustrated with reference to FIG. 3B. By way of example, one or more events may be present to the IM client. The results may include specific events with an option for the user of the IM client to request the IM server “Find Tickets” by opening a connection with the commerce server (block 230 further discussed below). The results may also allow the user of the IM client to request additional results that are “More Like This.” Further, the displayed results may allow the user of the IM client to select different or “More events” or provide “More options” to the user of IM client.

In the results for the query response, one of the selections may be to engage in a purchase request, such as is listed in FIG. 3B as the “Find Tickets” option. A block 228 determines if the user has selected the purchase request. If the user has selected the purchase request, then a block 230 opens a connection to the commerce server 130 where the user may then select tickets or other accommodations provided by the commerce server 130. If the connection was open with the commerce server 130, then a query 232 monitors for a completion of the purchase and returns back to the IM service when the purchase is completed or otherwise terminated.

If the user of the IM client did not select an event purchase request at query 228, then the process continuously monitors at query 234 to determine if the user navigated away from the bot application 176 in the IM service. If the user did navigate away from the bot application 176, then processing returns to conventional IM at block 202.

If the user did not navigate away from the bot application, then a block 236 further refines the query to obtain more criteria from the user to better narrow search results in an attempt to identify more tailored search results. The user may also make requests in the IM service to narrow or tailor the query from the bot application. After the query is refined in block 236, then the processing passes back to querying the user with an instant message in block 208. An example refined user query is illustrated with reference to FIG. 3C. In the example results of FIG. 3C, alternative events having similar criteria (e.g., event city) may be provided to the user of the IM client with similar options (e.g., “Find Tickets,” “More Like This,” and “More events” options as described above. The process then repeats with the user's query responses being processed by the IM server.

It should be noted that the query refining in block 236 may also include selection of kinds or types of events as illustrated in FIG. 3D. As illustrated in FIG. 3D, alternative event types may be selected such as “Sports” or “Concerts.” After a response to the query by the user of the IM client, then results may be presented according to the newly selected event type.

Further the query refining in block 236 may also include selection of more granular criteria as illustrated in FIG. 3E. In FIG. 3E, the query from the bot application may include a list of alternative search criteria. By way of example, options to “Let me pick the event type,” “Let me pick a date,” “Let me decide how much $.” “Location,” or “Start Over” allow the user to define and refine the criteria for generating the results. As illustrated by the example of FIG. 3E, the user upon selecting a response to the query of “Let me pick a date” may be further presented with options to further refine the results.

Results can then be displayed in the block 226 in an iterative manner. An example of the results for a more granular query are illustrated with referent to FIG. 3F and FIG. 3G. By way of example, FIG. 3F illustrates a selection of events for “This Weekend” with the most trending results displayed. Further, the user may also be presented with options, as described above, to “Find Tickets,” request results “More Like This,” and request further results by selecting “More events.” By way of example, FIG. 3G illustrates a selection of an alternative event city with some trending results displayed. Further, the user may also be presented with options, as described above, to “Find Tickets,” request results “More Like This,” and request further results by selecting “More events.”

The embodiments described herein may include the use of a special purpose or general purpose computer including various computer hardware or software modules. Further, embodiments described herein may be implemented using computer-readable media for having computer-executable instructions or data structures stored thereon.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and methods described herein are generally described as being implemented in software (stored on and/or executed by general purpose hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc. are not necessarily used herein to connote a specific order. Generally, the terms “first,” “second,” “third,” etc., are used to distinguish between different elements. Absence a showing of a specific that the terms “first,” “second,” “third,” etc. connote a specific order, these terms should not be understood to connote a specific order.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that various changes, substitutions, and alterations could be made hereto without departing from the spirit and scope of the present disclosure.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A system comprising:
an instant messaging server communicatively coupled with a commerce server and providing an application configured to support communication in an instant messaging service between an instant messaging client and the commerce server, the instant messaging server configured to perform operations comprising:
storing potential query responses in a cache, the potential query responses including responses that are selected for inclusion in the cache based on trending social media data;
receiving a query; and
automatically providing one of the potential query responses in response to the query from within the instant messaging service provided by the instant messaging server.

2. The system of claim 1, wherein the one of the potential query responses is a response to a request for a ticket to a live event.

3. The system of claim 1, wherein the potential query responses are selected for inclusion further based on trending topics on media other than social media.

4. The system of claim 1, wherein the potential query responses are selected for inclusion further based on inquiries at the commerce server.

5. The system of claim 1, wherein the potential query responses are selected for inclusion further based on completed transactions at the commerce server.

6. The system of claim 1, wherein the instant messaging server is further configured to open a connection between the instant messaging server and the commerce server in response to a purchase request being selected in response to the one of the potential query responses.

7. The system of claim 1, wherein the potential query responses are selected for inclusion further based on historical data for a user such that the potential query responses are tailored to the user.

8. The system of claim 2, wherein the trending social media data includes at least one of: a performer of the live event or a location of the live event.

9. A method performed by an instant messaging server, the method comprising:
providing an application configured to support communication in an instant messaging service between an instant messaging client and a commerce server that is configured to be communicatively coupled to the instant messaging server;
identifying potential query responses for inclusion in a cache at the instant messaging server based on trending social media data at the instant messaging server;
storing the potential query responses in the cache;
receiving a query at the instant messaging server; and
automatically providing one of the potential query responses in response to the query from within the instant messaging service provided by the instant messaging server.

10. The method of claim 9, wherein the one of the potential query responses is a response to a request for a ticket to a live event.

11. The method of claim 9, wherein identifying the potential query responses is further based on trending topics on media other than social media.

12. The method of claim 9, wherein identifying the potential query responses is further based on inquiries at the commerce server.

13. The method of claim 12, wherein identifying the potential query responses is further based on completed transactions at the commerce server.

14. The method of claim 9, further comprising:
receiving a purchase request in response to the one of the potential query responses; and
in response to the purchase request, opening a connection between the instant messaging server and the commerce server.

15. The method of claim 9, wherein identifying the potential query responses is further based on historical data for a user such that the potential query responses are tailored to the user.

16. The method of claim 10, wherein the trending social media data includes at least one of: a performer of the live event or a location of the live event.

17. A non-transitory machine-readable medium storing instructions that, when executed by a machine, cause the machine to perform operations comprising:
providing an application configured to support communication in an instant messaging service between an instant messaging client and a commerce server that is configured to be communicatively coupled to an instant messaging server;
identifying potential query responses for inclusion in a cache at the instant messaging server based on trending social media data;
sending an instruction to store the potential query responses in the cache of the instant messaging server;
receiving a query; and
automatically providing one of the potential query responses in response to the query from within the instant messaging service provided by the instant messaging server.

18. The machine-readable medium of claim 17, wherein the one of the potential query responses is a response to a request for a ticket to a live event.

19. The machine-readable medium of claim 17, wherein the potential query responses are selected for inclusion further based on historical data for a user such that the potential query responses are tailored to the user.

20. The machine-readable medium of claim 18, wherein the trending social media data includes at least one of: a performer of the live event or a location of the live event.
